(19) United States
(12) Patent Application Publication
(10) Pub. No.: US 2026/0103404 A1
(43) Pub. Date: Apr. 16, 2026

(54) FREEZE DESALINATION METHOD VIA INJECTION OF DRY ICE FIELD

(71) Applicant: PRD TECH, INC., Cincinnati, OH (US)

(72) Inventor: Rakesh GOVIND, Cincinnati, OH (US)

(73) Assignee: PRD TECH, INC., Cincinnati, OH (US)

(21) Appl. No.: 19/354,503

(22) Filed: Oct. 9, 2025

Related U.S. Application Data
(60) Provisional application No. 63/705,583, filed on Oct. 10, 2024.

(51) Int. Cl. C02F 1/22; C01C 1/16; C01D 7/12; C02F 1/44; C02F 103/08; C02F 103/10

(52) U.S. Cl. CPC C02F 1/22; C01C 1/164; C01D 7/12; C02F 1/441; C02F 2103/08; C02F 2103/10

(57) ABSTRACT

The present invention relates to a freeze desalination method where carbon dioxide, in the form of dry ice, is injected into saltwater. The carbon dioxide sublimes, which cause ice to form around the carbon dioxide bubble. The ice bubble floats to the top of the saltwater, and it can then be skimmed off the top and melted. This water has a low concentration of salt. It then can go through further desalination methods, such as reverse osmosis, to further purify the water. The embodiments described herein are not limiting and this can be accomplished by methods not described fully herein. Particularly, the present invention provides a direct freeze desalination (DFD) method wherein solid carbon dioxide pellets are injected into saline water, forming buoyant ice balls that are separated, washed, and melted. The process uniquely integrates CO₂ recycling, energy-saving compression, and optional mineral recovery to produce potable water with lower energy consumption compared to conventional methods

### FIELD

### Field of the Invention

The present invention relates to water desalination technologies, particularly to a method and system for producing potable water from saline or high-TDS wastewater by using dry ice injection and freeze desalination, with integrated carbon dioxide recycling and mineral recovery.

### Background

Conventional desalination methods such as multi-stage flash (MSF), multi-effect distillation (MED), and reverse osmosis (RO) suffer from high energy consumption, membrane fouling, and harmful brine discharge. Freeze desalination (FD) has potential advantages because salts are rejected from ice crystals, but conventional FD methods have limitations in purity, scalability, and energy efficiency.

Desalination methods can be classified into two categories—(1) those that include phase-change of saline water (vaporization and freezing), and (2) those that exclude phase-change of saline water. The first category of conventional desalination methods incorporates multi-effect distillation (MED), adsorption desalination (AD), multistage flash distillation (MSF), mechanical vapor compression (MVC), humidification/dehumidification (HDH), membrane distillation (MD), and freeze desalination (FD). The second category of desalination methods concerns reverse osmosis (RO), forward osmosis (FO), capacitive deionization (CDI), ultrafiltration (UF), nanofiltration (NF), and electrodialysis (ED).

The energy consumption and cost of potable water production are less for second-category desalination methods due to the absence of the phase change process. Similar trends can be observed for potable water production capacity and CO₂ emission. It is important to note that the conventional desalination methods (MED, MSF, MVC, HDH, MD, and RO) have a severe environmental impact on seawater temperature and salinity. The brine discharge increases seawater temperature and salinity significantly.

Brine is the by-product of a desalination process (both distillation and membrane-based). It is an aqueous mixture having a high concentration of NaCl and other chemical contaminants such as HCl, AlCl₃, NaOCl, NaHSO₃, H₂SO₄, and FeCl₃. The density of brine is higher than brackish water and seawater. Consequently, brine disposal contaminates the marine environment. Sea disposal, land disposal, and deep well injection of brine creates severe environmental concerns. Many methods (the evaporation pond, membrane distillation, forward osmosis, electrodialysis, and capacitive deionization) have been developed for brine treatment. The evaporation pond is effective only in an area with arid. Membrane-based methods are always prone to fouling. FD based on eutectic freezing can treat brine effectively. The process involves the simultaneous formation of ice and salt crystals. Their separation takes place due to their density difference. FD based on eutectic freezing is a potential method of mineral (sodium, magnesium, calcium, potassium, lithium, thorium, and uranium) recovery from seawater. This could lead to a reduction in the cost of potable water production from seawater.

U.S. Pat. No. 11,945,743B2 discloses a salt repellent technique is presented to remove all inorganic salts from seawater to get potable water. The repellent additives recommended throws out all salts of sodium, magnesium, calcium, potassium and the like ions from seawater and paves way to get salt free potable water. The conventional washing of ice crystals is completely avoided due to the presence of additives.

CA2659451C discloses a method of desalinating water, said method comprising: providing feed water; and subjecting said feed water to a desalination process to produce a desalinated product water and a waste brine; wherein said method further comprises employing a carbonate compound precipitation process at least once during said method comprising contacting said feed water with or said waste brine with CO₂ to form a carbonate product composition comprising calcium carbonate and strontium.

CN112047415A relates to the technical field of seawater desalination, in particular to a liquid CO₂ circulating frozen seawater desalination and mineralization equipment system and method. The further technical problem is to provide a method for desalination and mineralization by circulating frozen seawater with liquid CO₂.

US20210261438A1 relates, generally, to a desalination system and more particularly relates to a thermal and freeze desalination system for extracting potable water from raw water by utilizing liquefied natural gas as a cryo-condensation medium and thermal fuel.

U.S. Pat. No. 9,643,860B2 relates to systems and methods for desalinating and/or treating polluted water. In particular, the system comprises a desalination tank configured to form gas hydrates using a suitable hydrate former taken from a storage tank that is operatively connected to the desalination tank. With all operations, including formation of gas hydrates, discharging of highly saline water, washing the gas hydrates and dissociation of gas hydrates being conducted in a single pressurized tank such as the desalination tank, the present apparatus provides a simple and efficient solution at a low manufacturing and operating cost.

Senyao Zhao et al., Sustainability 2024, 16(22), 10138, Nov. 20, 2024 discusses experimental and simulation studies of different principles. This paper discusses the experimental progress and simulation methods associated with this, elaborates upon, and analyzes the freezing crystallization process and desalination efficiency from the perspective of the bottom layer of crystal growth, offering valuable insights for future research.

Hence, there remains a need for a low-energy desalination process capable of treating seawater, brackish water, frac water, and high-salinity oilfield wastewater while enabling recovery of CO₂ and minerals.

A benefit of the FD process is that it needs approximately 1/7th of the energy the vaporization-based desalination processes require. The insensitivity to fouling is another important benefit of FD compared to membrane-based desalination processes, which typically are prone to fouling and require frequent maintenance. In the case of excessive fouling, cleaning membranes is difficult. A benefit to the FD process is that there is no need for intensive pretreatment of the saltwater.

The involvement of sub-zero temperature in FD reduces the risk of corrosion and scaling. Furthermore, vaporization and membrane-based desalination methods produce concentrated brine, which causes environmental damage. FD can treat concentrated brine close to zero liquid discharge or standalone or integrating with membrane distillation and crystallization.

### SUMMARY

The present invention provides a direct freeze desalination (DFD) process that injects solid carbon dioxide (dry ice) particles into saline water. Sublimation of CO₂ rapidly freezes surrounding water into ice balls encapsulating CO₂ gas. These ice balls float to the surface due to buoyancy, are skimmed off, washed, and melted to yield low-salinity water. The gaseous CO₂ released is dried, compressed, and recycled to form new dry ice pellets.

Accordingly, the present invention provides a method of desalinating saline water, comprising injecting solid carbon dioxide particles into a column of saline water; allowing the particles to sublimate, thereby freezing water around the sublimating carbon dioxide and forming buoyant ice balls containing entrapped carbon dioxide gas; separating the buoyant ice balls at a surface of the column; washing the separated ice balls with desalinated water to remove residual saline water films; melting the ice balls to obtain water having a reduced concentration of dissolved salts and releasing the entrapped carbon dioxide; and recycling at least a portion of the released carbon dioxide by drying, compressing, and pelletizing to form additional solid carbon dioxide particles.

In an embodiment, the present invention provides that the solid carbon dioxide particles have a size between about 0.1 mm and 6 mm.

In an embodiment, the present invention provides that the saline water is pre-cooled to about 0-5° C. prior to injection of the solid carbon dioxide.

In an embodiment, the present invention provides that the carbon dioxide compression is performed with interstage cooling or with pre-cooling by a refrigeration system to reduce compression energy consumption.

In an embodiment, the present invention provides that the water obtained from melting the ice balls is further treated using a low-pressure reverse osmosis system.

In an embodiment, the present invention provides draining saline water entrained with the ice balls through a perforated collection pipe having apertures smaller than the ice balls.

In an embodiment, the present invention provides that the concentrated brine remaining after ice ball separation undergoes chemical reaction with ammonia and carbon dioxide in a vertical tube reactor to form sodium bicarbonate and ammonium chloride.

In an embodiment, the present invention provides that the comprising converting sodium bicarbonate into sodium carbonate while recycling carbon dioxide and ammonia for reuse in the method.

In an embodiment, the present invention provides a desalination system comprising a column reactor (1) configured to receive saline water and solid carbon dioxide particles, wherein sublimation of the solid carbon dioxide produces buoyant ice balls; a skimming and washing unit (2) configured to collect and wash the buoyant ice balls without centrifugation; a melting unit (3) fluidly connected to the skimming unit for melting the ice balls to produce desalinated water and release carbon dioxide gas; a carbon dioxide recovery loop (4) comprising a dryer, compressor with interstage cooling, and pelletizer for recycling the carbon dioxide gas into solid carbon dioxide particles; and optionally, a reverse osmosis unit fluidly connected downstream of the melting unit.

### BRIEF DESCRIPTION OF DRAWINGS

These and other features, aspects, and advantages of the present invention will become better understood when the following detailed description is read concerning the accompanying drawings in which like characters represent like parts throughout the drawings, wherein:

FIG. 1 is a graph that shows the concentration of the solute in the ice and severely affects its purity.

FIG. 2 depicts the schematic of the direct contact FD process.

FIG. 3 shows the potable water production capacity, energy consumption, and cost data for the different FD methods.

FIG. 4 illustrates direct freeze desalination of wastewater with high total dissolved solids.

FIG. 5 is a detailed schematic of a nozzle to be used in a possible embodiment.

FIG. 6 depicts an embodiment where the temperature decreased from room temperature as time elapsed, approached a stable temperature of −55±5° C., and decreased further.

FIG. 7 shows the particle size distribution of the dry ice particles for different glass tube sizes.

FIG. 8 shows a photograph of the water produced before the dry ice particles were introduced and the water obtained after melting the ice crystals skimmed off the water's surface.

FIG. 10 depicts the Vertical Tube Reactor (VTR) system, which consists of a plurality of tubes installed inside a vessel.

FIG. 11 depicts the formation of Sodium Carbonate and Calcium Chloride and the release of carbon dioxide and ammonia, which are recycled back to the first Vertical Tube Reactor (VTR).

FIG. 12 illustrates a low pressure reverse osmosis membrane system can easily produce drinking water.

Further, skilled artisans will appreciate that elements in the drawings are illustrated for simplicity and may not have been necessarily been drawn to scale. Furthermore, the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

In order to describe features of the disclosure, a more particular description of the presently described technology is rendered by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings.

The present invention provides a Freeze Desalination (FD) process which produces ice crystal/crystals and concentrated salt water. Freshwater is obtained by separating ice crystals/crystals from the concentrated saltwater and, afterward, melting it. The by-product of FD is concentrated saltwater (for freeze concentration-based desalination) or salt crystals (for eutectic freezing-based desalination).

The FD process increases the concentration of an aqueous solution by separating the dissolved solute from ice into the liquid, undergoing crystallization. The solute separation is because the ice crystal lattice has a small dimension that rejects solute ions. Additionally, the solute separation mechanism from the ice phase could be due to the insignificant solubility of solute ions in the ice phase compared to water. A high solute concentration layer is adjacent to the moving ice-liquid interface if the separated solute is not mixed into the liquid. As the layer grows, the ice-liquid interface traps the solute in the ice. This increases the concentration of the solute in the ice and severely affects its purity, as shown in FIG. 1.

To prevent the incorporation of salts at their higher concentration near the ice-water interface, the liquid boundary layer near the ice may be mixed, allowing the concentrated salts near the ice surface to mix with the rest of the water and convect away from the ice-water interface.

The growth rate of ice near the ice water interface also affects the purity of the ice. The ice grows as a flat surface at lower cooling rates, while at higher cooling rates, it grows as dendrites, columnar longer structures emanating from the ice surface, which allows salts to be incorporated into the ice. A higher degree of supercooling promotes the formation of dendritic ice structure, decreasing its purity.

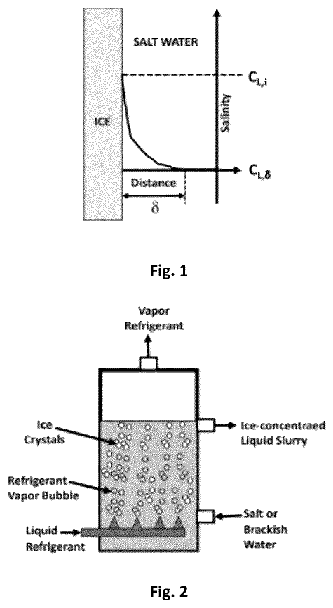

FD is classified into direct contact and indirect contact methods. FIG. 2 depicts the schematic of the direct contact FD process. The process uses a volatile secondary refrigerant of a refrigeration cycle. The cold liquid refrigerant is mixed directly with the saltwater in a crystallizer where refrigerant evaporation occurs due to heat transfer from saltwater. The saltwater gets frozen as ice crystals suspended in the concentrated saltwater. The ice crystals are separated from the concentrated saltwater and sent for post-treatment (for example, washing). Freshwater is obtained by melting post-treated ice crystals. The refrigerant is recycled into the crystallizer. The post-treatment of ice crystals is necessary because the salt in the concentrated liquid can contaminate the ice crystals.

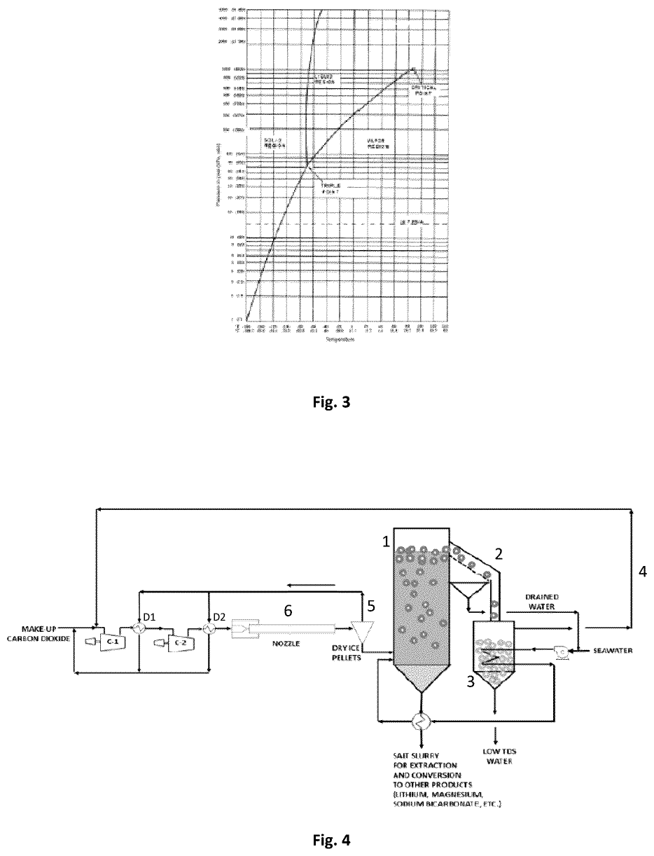

A phase change occurs between the liquidus and solidus temperatures for aqueous solutions like saltwater. The presence of salt reduces the liquidus temperature of the mixture. The phenomenon is known as freezing point depression (ΔT_{fpd}), which is expressed as:

$$Δ {T}_{fpd} = - ab ϕ$$

where a is the van't Hoff factor linked to the number of ion particles (for NaCl, a=2), b is the cryoscopic or molal depression constant (for water, b=1.853K·kg/mol), and φ is the molality of the saltwater (mole of NaCl/kg of water). It is important to note that the liquidus temperature of saltwater depends on the salt concentration in the mixture. As the freeze-concentration of the NaCl—H₂O mixture proceeds, the salt concentration in the liquid phase increases. This leads to a further reduction in the liquidus temperature. FIG. 3 shows the schematic of the NaCl—H₂O mixture equilibrium phase diagram. Consider the saltwater ‘A’ having sub-cutectic concentration and maintained at a sub-eutectic temperature. As the freeze desalination progresses, the mixture reaches the liquidus line (known as the ice line), and ice formation begins. If the saltwater ‘B’ has hypereutectic concentration, maintains a sub-cutectic temperature, and is cooled down, it reaches the solubility line, and salt crystal formation begins. It is necessary to emphasize that if salt crystals form first, the process is called cooling crystallization and not freeze-concentration due to the absence of ice formation. The eutectic point reaches upon further cooling both ‘A’ and ‘B.’ The eutectic point represents the lowest freezing point of the mixture (−21.1° C.) and the largest amount of salt (23.3 wt %) dissolved in the liquid phase.

The process of simultaneous ice and salt formation is called Eutectic Freeze Crystallization. During the process, ice floats in the mixture, and salt crystals settle at the bottom of the crystallizer. This makes the separation of both solid phases easy. This type of crystallization has been tried with butane, a highly flammable gas, which is liquefied and then introduced into the saltwater as a liquid droplet. Volatile refrigerants such as butane create a severe safety issue during the direct contact FD process because of their explosive nature.

The four most concentrated metal ions, Na⁺, Mg²⁺, Ca²⁺, and K⁺, are the only ones commercially extractable today, with the least concentrated of the four being potassium (K) at 400 parts per million (ppm). Below potassium, we go down to lithium, which has never been extracted in commercial amounts from seawater, with a concentration of 0.17 ppm. Other dissolved metal ions exist at lower concentrations, sometimes several orders of magnitude lower. None has ever been commercially extracted.

The data on potable water production capacity, energy consumption, and the cost for different FD methods reported in the literature is limited.

The present invention provides a method to produce potable drinking water from saline water using freezing, achieved by injecting tiny particles (in some implementations, 2 mm-6 mm) of dry ice (solid carbon dioxide) into saline water. The cooling of the water around the dry ice particles, as dry ice sublimes to form gaseous carbon dioxide, causes the water to form ice around the gaseous carbon dioxide bubble, which then rises rapidly through the water due to the low density of the ice and gas bubble. With carbon dioxide gas entrapped within the ice ball, the ice balls are skimmed off the surface using a conventional skimmer mechanism and then melted to release the gaseous carbon dioxide and liquid water. This water has a low concentration of salts, which can then be further desalted using conventional reverse osmosis membranes, operating at a lower pressure than would be needed if sea or brackish waters were desalinated directly using reverse osmosis. A schematic of the invention is shown in FIG. 4. The embodiments set forth are illustrative and should not be treated as limiting.

In some embodiments of this invention, the first part of the process consists of the saltwater being pumped through an air flotation process to remove any suspended and settleable solids. The water from this process is then pumped to the high-rate crystallizer process, where dry ice particles are injected to form ice surrounding the gaseous carbon dioxide. These carbon dioxide bubbles enclosed in ice are skimmed from the surface and heated, which creates water and gaseous carbon dioxide. The gaseous carbon dioxide can be recycled back to the dry ice pellet-making process.

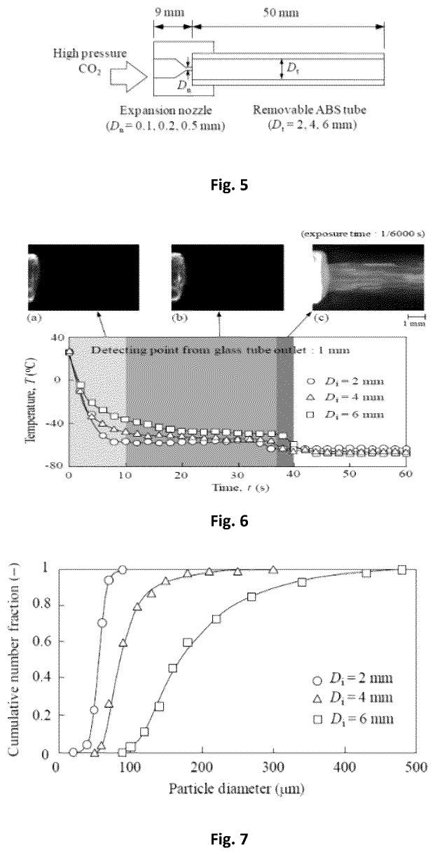

Carbon dioxide was expanded from the nozzle at a primary pressure of 6.5±0.2 MPa to atmospheric pressure. The expanded gas flow was cooled by rapid expansion. To avoid direct contact between the expanded flow and the surrounding air, a glass tube was installed at the outlet of the nozzle, as shown in FIG. 5, and experiments were carried out under the same conditions as above. The dry ice particles were visually observed in the glass tube's jet flow. In this experiment, glass tubes with different diameters were also used. Although there were slight differences in the results, the temperature variations were almost the same. Next, the time course of the temperature in the jet flow was measured. In an embodiment depicted in FIG. 6, the temperature decreased from room temperature as time elapsed, approached a stable temperature of −55±5° C., and decreased further. The secondary stable temperature in this embodiment was −65° C., i.e., two stages of temperature decrease in the jet flow. After the secondary temperature decreased, dry ice particles were observed visually in the jet flow from the glass tube. Thus, the secondary temperature decrease is significant in the occurrence of this phenomenon. Dry ice particles ejected from the nozzle are thought to sublimate initially to cool down the tube. As the tube's temperature decreases, the heat exchange rate decreases, and the jet temperature approaches to be stable.

FIG. 6 shows a schematic diagram of this embodiment's experimental apparatus. High-purity liquid carbon dioxide was used to produce dry ice particles. A flexible thermally insulated hose, 2 m long and 15 mm in inner diameter was connected between a high-pressure carbon dioxide cylinder and an expansion nozzle. A pressure gauge was installed to measure the pressure of the carbon dioxide. In this study, the pressure was kept at 5.5 MPa. FIG. 5 shows the details of the nozzle. Three nozzle sizes were used to introduce the different flow rates of the dry ice jet. The mass flow rates for 0.1, 0.2, and 0.5 mm nozzles were 0.2, 0.5, 2.9 g/s, respectively. An acrylonitrile-butadiene-styrene (ABS) tube of 2, 4, or 6 mm inner diameter and 50 mm in length was attached to the outlet of the expansion nozzle to produce agglomerated dry ice particles. The size distribution of the dry ice particles ejected from the nozzle or the tube was measured in situ with a particle size analyzer (Spraytec, Malvern Instruments Inc.) based on the laser diffraction method. The laser beam, with a diameter of 20 mm, was oriented perpendicular to the dry ice jet.

FIG. 7 shows the particle size distribution of the dry ice particles for different glass tube sizes. The data shows unsymmetrical distributions, which means a small amount of larger agglomerates were produced. Bench scale experiments were conducted using the dry ice particles and produced water, which typically has a very high concentration of salts.

FIG. 8 shows a photograph of the water produced before the dry ice particles were introduced and the water obtained after melting the ice crystals skimmed off the water's surface. The recovery of water was 98%, which resulted in a dense slurry of salts in the liquid left behind after the ice crystals were recovered.

Table 1. summarizes the experimental data on plant capacity, energy consumption, cost, operating temperature, environmental impact, and CO₂ emission linked with different desalination methods.

| | | | | | Salinity of | Salt | Water | Technique | |
|---|---|---|---|---|---|---|---|---|---|
| | | | | Salinity | concentrated | removal | recovery | to enhance | |
| | | Mode of | Type of | of ice, | liquid, | efficiency, | efficiency, | the ice | |
| Reference | Equipment | operation | saltwater | Cₛ (wt %) | Cₗ (wt %) | S (%) | W (%) | purity | Other findings |
| Erlbeck et | Stirred | Batch | Brackish | 0.01 | N.A. | 99 | 22 | Ice | Intense stirring |
| al.⁴⁹ | cylindrical | | water | | | | | pressing | decreased the rate of |
| | crystallizer | | (C_{l, 0} = | | | | | | ice formation. |
| | cooled | | 1 wt %) | | | | | | |
| | laterally | | | | | | | | |
| Zvinowandaet | HybridICE ™ | Batch | Brackish | 0.04 | 2.24 | 97.5 | 50 | N.A. | The ice yield was |
| al.⁵¹ | unit | | water | | | | | | inversely proportional |
| | including a | | C_{l, 0} = | | | | | | to the liquid circulation |
| | refrigeration | | 1.47 wt %) | | | | | | flow rate and scrapper |
| | unit and | Continuous | Brine | 1.7 | 7.08 | 82.8 | 34 | | motor speed. |
| | scraped | | C_{l, 0} = | | | | | | |
| | surface heat | | 4.92 wt %) | | | | | | |
| | exchangers | | | | | | | | |
| Erlbeck et | Screw based | Batch | Seawater | 0.01 | N.A. | 99.7 | N.A. | Ice | Salinity reduction for |
| al.^{52, 53} | scraped | | C_{l, 0} = | | | | | pressing | seawater reached above |
| | surface heat | | 3.5 wt %) | | | | | | 99% at the subcooling |
| | exchanger | | | | | | | | of approximately 4 K. |
| | with ice | | | | | | | | The optimum force to |
| | pressing unit | | | | | | | | press ice and holding |
| | | | | | | | | | time was found to be |
| | | | | | | | | | 37.4 kN and 180 s, |
| | | | | | | | | | respectively. |
| Shin et al.⁵⁴ | Scraped | Batch | Seawater | 0.18 | 5 | 94.9 | 40 | Washing | Ice seeding was not |
| | surface heat | | C_{l, 0} = | | | | | | required for producing |
| | exchanger | | 3.5 wt %) | | | | | | irrigation water. |
| Sahu et al.⁵⁵ | U-shaped | Continuous | Seawater | 0.80 | N.A. | 77.1 | 15 | Washing | The two-step washing |
| | scraped | | C_{l, 0} = | | | | | | of ice was observed to |
| | surface | | 3.5 wt %) | | | | | | be effectual in |
| | crystallizer | | | | | | | | decreasing salinity |
| | which | | | | | | | | compared to single-step |
| | integrates | | | | | | | | washing. |
| | precooling, | | | | | | | | |
| | freezing and | | | | | | | | |
| | ice removal | | | | | | | | |
| Abdelmoatyet | A cylindrical | Batch | Brackish | 1.67 | N.A. | 44.3 | 15.6 | N.A. | Increase in the |
| al.⁵⁶ | tank cooled | | water | | | | | | intensity of the |
| | peripherally | | C_{l, 0} = | | | | | | magnetic field |
| | | | 3 wt %) | | | | | | increased the ice purity |
| | | | | | | | | | by decreasing the |
| | | | | | | | | | concentration gradient |
| | | | | | | | | | near the ice-liquid |
| | | | | | | | | | interface. |

Note:
N.A. Not available.

Table 2 summarizes the experimental data on plant capacity, energy consumption, cost, operating temperature, environmental impact, and CO₂ emission linked with different desalination methods.

| | | | Electrical | Thermal | | | | |
|---|---|---|---|---|---|---|---|---|
| | | Plant | energy | energy | | Operating | | CO₂ |
| Desalination | Type of | capacity | Consumption | Consumption | Cost | temperature | | emission |
| method | saltwater | (m3/h) | (kWhₑₗₑ /m³) | (kWhₜₕ/m³) | (US $/m³) | (° C.) | Environmental impact | (kg/m³) |
| RO | Seawater | 40-13,000 | 5.1-7.5 | Not | 0.5-1.7 | Ambient | Brine discharges at ambient | 1.7-2.8 |
| | (C_{l, 0} = | | | applicable | | | temperature, and TDS | |
| | 3.5 wt %) | | | | | | increases by 50-80%. | |
| RO | Brackish water | 0.5-1600 | 2-5 | Not | 0.3-0.5 | Ambient | Concentrated saltwater | 1.7-2.8 |
| | (C_{l, 0} < | | | applicable | | | discharges at ambient | |
| | 3 wt %) | | | | | | temperature, and TDS | |
| | | | | | | | increases by 50-80%. | |
| FO | Brackish water | 0.5-1000 | 3-8 | Not | 0.2-0.6 | Ambient | Concentrated saltwater | N.A. |
| | (C_{l, 0} < | | | applicable | | | discharges at ambient | |
| | 3 wt %) | | | | | | temperature. | |
| ED | Brackish water | 4-850 | 2.6-23 | Not | 0.6-1.05 | Ambient | Concentrated saltwater and | N.A. |
| | (C_{l, 0} < | | | applicable | | | brine discharges at ambient | |
| | 0.5 wt %) | | | | | | temperature. | |
| MVC | Seawater | 250-1250 | 7-12 | Not | 0.7-1.1 | 65-70 | Brine discharge is 10-15° C. | 7.0-17.6 |
| | (C_{l, 0} = | | | applicable | | | hotter than ambient, and TDS | |
| | 3.5 wt %) | | | | | | increases by 15-20%. | |
| MED | Seawater | 5-13,000 | 12-19 | 40-65 | 1.1-2.0 | 65-70 | Brine discharge is 10-15° C. | 7.0-17.6 |
| | (C_{l, 0} = | | | | | | hotter than ambient, and TDS | |
| | 3.5 wt %) | | | | | | increases by 15-20%. | |
| MSF | Seawater | 950-22,000 | 20-27 | 53-70 | 1.9-2.5 | 90-110 | Brine discharge is 10-15° C. | 15.6-25.0 |
| | (C_{l, 0} = | | | | | | hotter than ambient, and TDS | |
| | 3.5 wt %) | | | | | | increases by 15-20%. | |
| MD | Brackish water | 0.1-17 | 35-40 | 80-100 | 3.2-3.7 | 60-90 | Concentrated saltwater and | 7.0-17.6 |
| | (C_{l, 0} < | | | | | | brine discharge is 10-15° C. | |
| | 3 wt %) and | | | | | | hotter than ambient, and TDS | |
| | Seawater | | | | | | increases by 15-20%. | |
| | (C_{l, 0} = | | | | | | | |
| | 3.5 wt %) | | | | | | | |
| HDH | Seawater | 0.4-1.1 | 40-60 | 100-200 | 3.7-5.6 | 65-70 | Brine discharge is 10-15° C. | 7.0-17.6 |
| | (C_{l, 0} = | | | | | | hotter than ambient, and TDS | |
| | 3.5 wt %) | | | | | | increases by 15-20%. | |

Note:
N.A. Not available.

Table 3 depicts the block freeze concentration process and the potable water production capacity, energy consumption, and cost data for the different FD methods.

| | | | Use of LNG | Plant capacity | Energy consumption | Cost |
|---|---|---|---|---|---|---|
| Reference | FD method | Type of saltwater | cold energy | (m³/h) | (kWhₑₗₑ/m3) | (US$/m3) |
| Erlbeck et | Stand-alone SFC based FD | Seawater (C_{l, 0} = 3.5 wt %) | No | N.A. | 30.7 | 2.9 |
| al.⁵³ | | | | | | |
| Mtombeni et | Stand-alone SFC based FD | Brackish water (C_{l, 0} = | No | 0.042 | 21-26 | 2-2.4 |
| al.⁹⁵ | | 1.47 wt %) | | | | |
| Chen et al.⁹⁶ | Stand-alone SFC based FD | Seawater (C_{l, 0} = 3.5 wt %) | No | 0.014 | 6.7-13.3 | 0.6-1.2 |
| Rane and | Stand-alone PFC based FD | Seawater (C_{l, 0} = 3.5 wt %) | No | 1 | 9-11 | 0.8-1.0 |
| Padiya¹⁵ | | | | | | |
| Rich et al.⁹⁷ | Stand-alone PFC based FD | Seawater (C_{l, 0} = 3.5 wt %) | No | 0.0000015 | N.A. | N.A. |
| Zambrano et | Integration of FFFC, FT | Seawater (C_{l, 0} = 3.5 wt %) | No | 0.743 | 11.5 | 1.1 |
| al.⁶² | and BFC based FD | | | | | |
| Chang et al.⁶⁸ | Stand-alone SFC based FD | Seawater (C_{l, 0} = 3.5 wt %) | Yes | 0.000525 | N.A. | N.A. |
| Wang and | SFC based FD and DCMD | Seawater (C_{l, 0} = 3.5 wt %) | Yes | 0.01144 | 4.6 | 0.4 |
| Chung⁷⁰ | hybrid system | | | | | |

Note:
N.A.: Not available.

From Tables 2 and 3, it is clear that the potable water production capacity is low for the FD methods compared to other desalination methods (RO, FO, MD, ED, MSF, MVC, MED, and HDH). The slow growth rate of ice crystals resulted in low plant capacity. Furthermore, most of the FD investigations are limited to laboratory-scale experiments. Most other desalination methods (RO, MSF, MVC, MED, and HDH) are well-established technologies and have been operating commercially for decades.

Dry ice is a solid state of CO₂ with a density in the range of 1400 to 1600 kg m⁻³, and it cannot permanently exist at room conditions, i.e., 1 atm and 25° C. shows the phase diagram of CO₂. When the conditions are below the triple point (−56.4° C., and 5.13 atm), CO₂ changes from a solid to a gas without intervening liquid state; this process is known as sublimation. On the other hand, the process where CO₂ changes from a gas to a solid state is called deposition. These features are particularly different from most other materials whose gas state intervenes with the liquid state before changing into a solid state. Since dry ice exists only at low temperatures, it can be applied as a kind of cryogenic particle.

Table 4 shows the composition of produced water in an embodiment in which the dry ice particles were introduced at the bottom of a 5 ft high column, 4 inches in diameter.

| Wastewater | | |
|---|---|---|
| Parameter | Value (units) | |
| pH | 7.0 | |
| TDS | 126,400 | mg/L |
| Na⁺ | 32,000 | mg/L |
| Mg⁺⁺ | 650 | mg/L |
| Ca⁺⁺ | 8,900 | mg/L |
| Sr⁺⁺ | 2,200 | mg/L |
| Ba⁺⁺ | 5,700 | mg/L |

| | |
|---|---|
| Fe⁺⁺ | 35 |
| Mn⁺⁺ | 2.8 |
| Cl⁻ | 62,800 |
| SO4²⁻ | 0 |
| SiO₂ | 0 |
| Hardness as Ca⁺⁺ | 11,300 |
| ²²⁶Ra | 4,600 |
| TSS | 100 |
| Turbidity | 35 |
| TOC | 89 |

The column was insulated to minimize heat flow from the outside into the water produced as it cooled down and began to form ice crystals. These ice crystals were skimmed off the surface of the water and melted. Analysis of the melted water resulted in water composition with 1200 mg/L of Total Dissolved Solids (TDS).

The Direct Freeze Desalination (DFD) process as illustrated in FIG. 4 uses dry ice nanoparticles to purify highly saline wastewaters like seawater, brackish, and frac water. By injecting dry ice into these waters, carbon dioxide sublimates and causes water to freeze around the nanoparticles, forming ice bubbles that float to the surface. These ice bubbles are skimmed off and melted, reducing total dissolved salts from 100,000 mg/L to 1,000-3,000 mg/L. This water is then further desalinated using low-pressure reverse osmosis. The DFD process efficiently consumes only 14% of the energy needed for evaporation and 35% for reverse osmosis, making it a promising solution for treating high-salinity wastewater and recovering valuable minerals.

The process consists of compressing recycled carbon dioxide and make-up carbon dioxide using multistage compressors with interstate cooling to minimize the compression energy. Alternatively, the carbon dioxide gas (recycled and make-up) can be precooled using a standard refrigeration system before the gas is compressed. The refrigeration system can have a working fluid, such as ammonia or any other appropriate chemical used in common refrigeration applications. The use of the refrigeration system to pre-cool the carbon dioxide is also an important embodiment of the patent.

The Direct Freezing Desalination (DFD) system utilizes carbon dioxide as a refrigerant medium to achieve seawater desalination through a controlled freezing mechanism. The system operates in a closed-loop configuration to maximize thermal efficiency and minimize energy consumption by recycling cold carbon dioxide gas and reusing thermal energy from internal process streams.

In one embodiment, the system comprises a carbon dioxide circulation loop including a make-up carbon dioxide supply, one or more compressors (C-1, C-2), a shell and tube heat exchanger (D1 and D2), an expansion nozzle (6), and a cyclone separator (5). The influent carbon dioxide gas is compressed and then introduced into the shell and tube heat exchanger, wherein the carbon dioxide gas flows through the tubes and is cooled by recycled cold carbon dioxide gas flowing in the shell side. The recycled gas originates from the cyclone separator after expansion, thereby enhancing energy efficiency through regenerative cooling.

The cooled carbon dioxide gas is expanded through a nozzle, wherein the gas undergoes adiabatic expansion to produce a mixture of solid dry ice particles and cold gaseous carbon dioxide. The expanded stream is then directed to a cyclone separator, which separates the higher-density solid dry ice particles from the lower-density cold gaseous carbon dioxide. The gaseous carbon dioxide, after separation, is recycled back (4) to the shell and tube heat exchanger to cool the incoming compressed carbon dioxide gas, while the separated solid dry ice particles are directed to the freezing section.

The freezing section comprises a tall water column (1) containing seawater, into which the solid dry ice particles are introduced. The dry ice particles come into direct contact with the seawater, causing rapid cooling and partial freezing of the seawater to form solid ice balls. The exclusion of salts during ice formation results in separation of desalinated ice from concentrated brine. The system further comprises a heat transfer element within an ice ball tank of the melting unit (3), wherein influent seawater flows internally through the element and the ice balls are positioned externally around it. As the ice balls melt, the inflowing seawater—entering at ambient temperature—is cooled by the melting ice balls (2). The cooled seawater is then directed to exchange heat with a salt slurry stream exiting from the bottom of the tall water column, resulting in further cooling of the influent seawater before re-entry into the freezing column. This sequential heat exchange minimizes refrigeration load and improves thermodynamic efficiency.

The system further includes a drainage collection system positioned along the conduit through which the ice balls move downward by gravity from the tall water column to the ice ball collection tank. The conduit is provided with drainage holes smaller than the diameter of the ice balls, allowing any seawater adhering to or entrained with the ice balls to be drained off without loss of solid ice. The drained seawater, containing residual salts, is collected in a triangular collection chamber and is subsequently directed back to the influent seawater line for reuse, thereby preventing saline leakage and maintaining system salinity balance.

Upon melting, the ice balls produce low total dissolved solids (TDS) water, suitable for potable or industrial use. The concentrated salt slurry discharged from the lower section of the water column is directed for further processing to recover valuable minerals such as lithium, magnesium, and sodium bicarbonate, thereby improving process economics and sustainability. The overall system provides a closed-loop, energy-efficient desalination process with integrated mineral recovery and minimal environmental discharge.

Pre-cooling the carbon dioxide gas before compression can save 10-15% of the energy used in compressing carbon dioxide at room temperature, while interstage cooling can reduce energy of compression by 20-25%, compared to no inter-stage cooling.

Compressed carbon dioxide is expanded through a special nozzle to create dry ice pellets and some of the cooled gas does not form dry ice. The cold CO₂ is separated from the dry ice pellets using a cyclone, with the cold gas being recycled to get interstage cooling between the multi-stage compressors.

The dry ice pellets are introduced into the bottom section of a column reactor (1) in which cold sea/brackish water is also introduced. The sea/brackish water is also pre-cooled using melting ice balls and the cold slurry leaving the bottom of the water column using heat exchangers. The dry ice pellets are at a significantly lower temperature than the water inside the water column, and this causes the dry ice pellets to sublime into carbon dioxide gas resulting in the formation of ice surrounding the pellets, resulting in the formation of ice balls with gaseous carbon dioxide inside them. This causes these ice balls to rise through the water column rapidly due to their significantly lower density.

A second effect of cooling the sea/brackish water in the water column is the precipitation of salts due to their lowered solubility. Typically, for the DFD process, sea/brackish water available at 25° C. is cooled down due to the injection of dry ice pellets to about 0 to 5° C.

The carbon dioxide gas released by melting the ice balls is dried (not shown in the figure) and recycled back. There is some consumption of carbon dioxide gas in the formation of carbonates from the salts in the sea/brackish water. Make-up carbon dioxide gas is supplied to overcome this loss of carbon dioxide due to reaction with the salts, typically present in the sea/brackish water.

Any sea/brackish water that leaves with the ice balls when they are skimmed from the surface of the water column is drained out using a pipe with holes at the bottom, and this water is collected and returned back to the incoming sea/brackish water. The holes are smaller than the size of the ice balls being skimmed from the surface. Furthermore, the ice balls can be washed with the desalinated water (not shown in the drawing) to remove any sea/brackish water film around the ice balls. This wash water together with any water drained from the ice balls is returned back to the inlet sea/brackish water feed.

It is important to emphasize why salts in the water are not contained within the ice structure as ice is forming around the dry ice pellets. The temperature of dry ice is −78.5° C. and the sublimation energy required to convert to gaseous carbon dioxide is 573 kJ/kg, while the latent heat for fusion of water is 334 kJ/kg. Hence, for every kg of ice, there is 1.716 kg of ice formed as the ice balls. Due to the large temperature difference between the dry ice at −78.5° C. and the sea/brackish water at temperature of 0 to 5° C. results in very rapid ice formation around the dry ice pellet, and due to this very rapid freezing, salts in the sea/brackish water are excluded from the ice structure. This is also an important difference between the DFD process and other methods of freezing water to obtain ice. Furthermore, since the ice formation is around the dry ice pellet and not on a cold surface, no adhesion issues with surfaces occur.

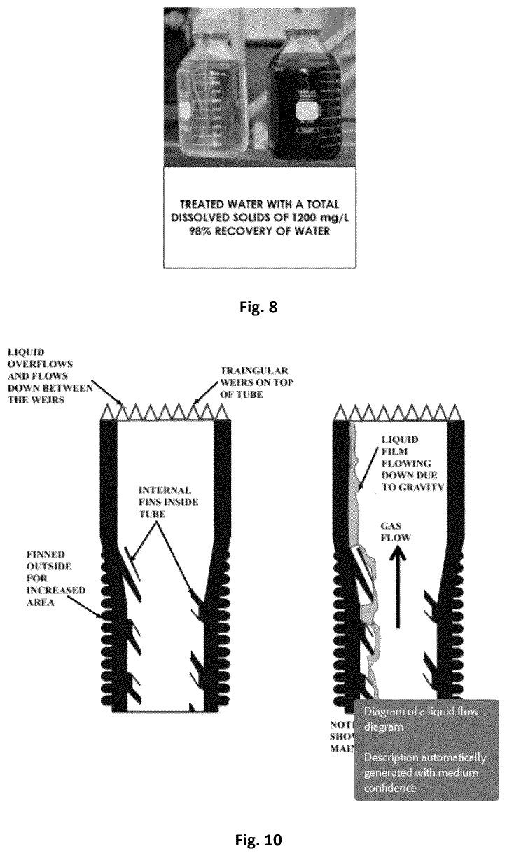

In another embodiment of the invention, using the Solvay Process and the use of a unique Vertical-Tube Reactor (VTR) system, the concentrated salt brines can be used to produce sodium carbonate. The ammonia and carbon dioxide with concentrated brine undergo a reaction. The Vertical Tube Reactor (VTR) system consists of a plurality of tubes installed inside a vessel, as shown in FIG. 10. The concentrated salt brine overflows into the inside surface of the multiple tubes, which have corrugations on the inside surface of the tubes, as shown in FIG. 10. These corrugations create a turbulent flow of the brine, as it flows down by gravity. Ammonia and carbon dioxide gases flow in the countercurrent direction upwards through the tubes as the concentrated brine is flowing down along the inner surface of the tubes. The turbulent brine flow, which can be a slurry, allows rapid reaction of the salt in the brine to form Sodium Bicarbonate (NaHCO₃) and Ammonium Chloride (NH₄Cl). The solid sodium bicarbonate is filtered out of the aqueous ammonium chloride solution, and the subsequent separation of the ammonia from the ammonium carbonate, based on the following chemical reactions:

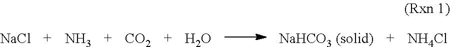

The aqueous solution of ammonium chloride (NH₄Cl) is reacted with Calcium Hydroxide ((Ca(OH)₂) to form calcium chloride (CaCl2) and release ammonia gas, which can be recycled back to the first vertical tube reactor.

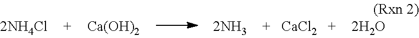

Calcium chloride is also a commercially important product. This reaction can also be conducted in a second Vertical Tube Reactor (VTR) to allow the ammonia gas to be removed efficiently and recycled back to the first Vertical Tube Reactor, as shown in FIG. 6.

Carbon dioxide can be obtained by calcining calcium carbonate (limestone) at a high temperature to form calcium oxide and carbon dioxide gas.

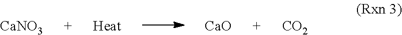

Calcium oxide (CaO) can be reacted with water to form calcium hydroxide. Both the calcium hydroxide and carbon dioxide can be used Rxn 2 and Rxn 1, respectively.

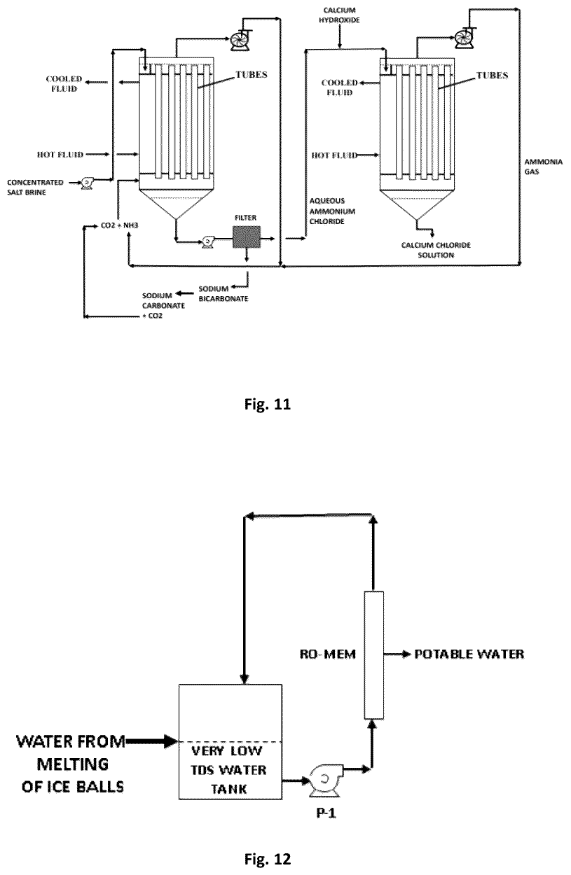

The mixture of Sodium bicarbonate and Ammonium chloride is mixed with Calcium Hydroxide (Ca(OH)₂) and then flowed down a second Vertical Tube Reactor (VTR), again with corrugations (refer to FIG. 10) on the inside of the tubes to allow the liquid to flow down by gravity under turbulent conditions. This results in the formation of Sodium Carbonate and Calcium Chloride and the release of carbon dioxide and ammonia, which are recycled back to the first Vertical Tube Reactor (VTR), as shown in FIG. 11. The sodium bicarbonate which precipitates as a solid can be filtered out from the aqueous solution of ammonium chloride. This solid sodium bicarbonate can be heated in the second vertical tube reactor, to decompose the sodium bicarbonate into sodium carbonate and carbon dioxide, as per the following reaction:

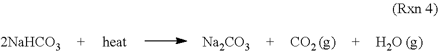

The carbon dioxide can be recycled back to the first vertical tube reactor, where the carbon dioxide is a reactant (see Rxn 1). Sodium carbonate is an important industrial product, with a huge commercial market.

In an embodiment, after the ice balls are melted releasing the carbon dioxide, there will be some salts left in the melted water due to the adherence of a water film around the ice balls, even after washing with desalinated water. However, these salt concentration in the melted water will be small and hence a low-pressure reverse osmosis membrane system can easily produce drinking water, as shown in the FIG. 12.

In view of the above, in another embodiment of the invention, the present invention integrates:
Pre-cooling of CO₂ before compression using interstage cooling or refrigeration cycles to reduce energy consumption.
Columnar crystallization where ice balls form and rise, while salts precipitate due to solubility reduction.
Low-pressure RO polishing of melted water to achieve potable standards.
Mineral recovery from concentrated brines using reactions (e.g., Solvay process) to extract sodium carbonate and calcium chloride, with ammonia and CO₂ recycling.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

### ADVANTAGES

65-85% energy savings compared to evaporation and RO.
Scalable to continuous operation.
Enables near zero-liquid discharge and mineral recovery.
Environmentally sustainable due to CO₂ reuse.

What is claimed is:

1. A method of desalinating saline water, comprising:
a. injecting solid carbon dioxide particles into a column of saline water;
b. allowing the particles to sublimate, thereby freezing water around the sublimating carbon dioxide and forming buoyant ice balls containing entrapped carbon dioxide gas;
c. separating the buoyant ice balls at a surface of the column;
d. washing the separated ice balls with desalinated water to remove residual saline water films;
e. melting the ice balls to obtain water having a reduced concentration of dissolved salts and releasing the entrapped carbon dioxide; and
f. recycling at least a portion of the released carbon dioxide by drying, compressing, and pelletizing to form additional solid carbon dioxide particles.

2. The method of claim 1, wherein the solid carbon dioxide particles have a size between about 0.1 mm and 6 mm.

3. The method of claim 1, wherein the saline water is pre-cooled to about 0-5° C. prior to injection of the solid carbon dioxide.

4. The method of claim 1, wherein carbon dioxide compression is performed with interstage cooling or with pre-cooling by a refrigeration system to reduce compression energy consumption.

5. The method of claim 1, wherein the water obtained from melting the ice balls is further treated using a low-pressure reverse osmosis system.

6. The method of claim 1, further comprising draining saline water entrained with the ice balls through a perforated collection pipe having apertures smaller than the ice balls.

7. The method of claim 1, wherein concentrated brine remaining after ice ball separation undergoes chemical reaction with ammonia and carbon dioxide in a vertical tube reactor to form sodium bicarbonate and ammonium chloride.

8. The method of claim 7, further comprising converting sodium bicarbonate into sodium carbonate while recycling carbon dioxide and ammonia for reuse in the method.

9. A desalination system comprising:
i. a column reactor (1) configured to receive saline water and solid carbon dioxide particles, wherein sublimation of the solid carbon dioxide produces buoyant ice balls;
ii. a skimming and washing unit (2) configured to collect and wash the buoyant ice balls without centrifugation;
iii. a melting unit (3) fluidly connected to the skimming unit for melting the ice balls to produce desalinated water and release carbon dioxide gas;
iv. a carbon dioxide recovery loop (4) comprising a dryer, compressor with interstage cooling, and pelletizer for recycling the carbon dioxide gas into solid carbon dioxide particles; and
V. optionally, a reverse osmosis unit fluidly connected downstream of the melting unit.
